(19) United States
(12) Patent Application Publication
(10) Pub. No.: US 2004/0232086 A1
(43) Pub. Date: Nov. 25, 2004

(54) Method and device for removing waste water samples

(76) Inventors: Oliver Bettmann, Florsheim (DE); Michael Tottewitz, Dieburg (DE)

Correspondence Address: BURNS DOANE SWECKER & MATHIS L L P, POST OFFICE BOX 1404, ALEXANDRIA, VA, 22313-1404, US

(21) Appl. No.: 10/476,578

(22) PCT Filed: May 2, 2002
(86) PCT No.: PCT/EP02/04811

(30) Foreign Application Priority Data
May 10, 2001 (DE) 10122801.5

(51) Int. Cl. C02F 1/48

(52) U.S. Cl. 210/748; 210/791

(57) ABSTRACT

In order to remove waste water samples, particularly for photometric analysis, a quantity of filtrate is suctioned through a filtrate mesh (5) and a sample is removed therefrom and then analysed. The filtrate mesh (5) is purified in an intermittent manner in-between the removal of the samples. Said filtrate mesh (5) is electrically conductive and is impinged upon by a positive electric potential as an anode during the intermittent purifying steps in order to carry out anodic oxidation, during which a separated cathode (22, 34) is impinged upon by a negative electric potential. Said quantity of filtrate is suctioned into a filter chamber (2) through the filter mesh (5) by producing a depression. Said depression is essentially suppressed before and/or during the removal of the sample from the filter chamber (2).

The invention relates to a method for removing waste water samples, particularly for photometric analysis, whereby a quantity of filtrate is moved by suction through a filter mesh and a sample is removed therefrom and then analyzed, and whereby the filter mesh is intermittently cleaned between the removal of samples.

During analysis of waste water samples, the content of solids in the waste water must be kept back through filtration in the removal of samples. Solid particles can clog-up the analyzing device in all employed analyzing methods. Cloudiness of the water samples caused by solids would falsify the measuring results in photometric analysis during which a color change is optically detected after adding a color reagent. Especially effective filtration is therefore required for photometric analysis of waste water samples.

However, the requirement for a very fine filter element has the disadvantage that the required fine filter meshes clog-up in a relatively short time. In obtaining waste water samples, there is the great difficulty that a simple and traditional filter backwash is not sufficient to clean the filter surface since biological germs contained in waste water lead to biological growth on the filter surface.

Such biological growth can be removed only partially through mechanical cleaning of the filter, especially since the small filter pores cannot be reached completely therewith. Even the cleaning by adding chemically effective cleaning solutions works only insufficiently and is time-consuming. This applies mostly to very fine filters, such as the ones necessary to obtain waste water samples for photometric analysis.

It is therefore the object of the invention to provide a method of the aforementioned type to make effective cleaning of very fine filter meshes possible using technologically and constructively simple measures.

This object is achieved according to the invention in that the filter mesh is electrically conductive and charged with positive electric potential as an anode during intermittent cleaning steps to carry out anodic oxidation while a cathode separated from said filter mesh is charged with negative electric potential. Cleaning of the filter mesh occurs through anodic oxidation. Oxidants developing directly on the surface of the filter mesh oxidize the biological growth and thus prevent clogging of the filter through such growth. The water sample itself is thereby exclusively subject to mechanical filtration and not subject to chemical or electrochemical influence.

Since the cleaning process occurs through charging with electric current, this cleaning process can be employed especially advantageously in analyzing devices that are immersed in form of a buoy into waste water to be tested. It is not necessary to pull the analyzing device from the waste water and place it in a position for maintenance to remove the biological growth through anodic oxidation. Anodic oxidation can thereby be performed at relatively short intervals and at the proper time so that a substantial increase of flow resistance in the filter mesh is prevented. Energy requirements are thereby kept low. This is especially advantageous for analyzing devices that are immersed in the form of buoys into the waste water to be tested (so-called in-situ analyzers).

According to an advantageous embodiment of the inventive idea it is proposed that a quantity of filtrate is moved by suction through the filter mesh into a filter chamber by creating negative pressure and that the negative pressure is mostly formed before and/or during the removal of the sample from the filter chamber.

It is achieved thereby that the energy requirement remains very low to remove the waste water sample from the filter chamber and to feed it into the analyzing device. In addition, forming of bubbles during sample removal is prevented to the greatest extent, which would occur at increased negative pressure.

The invention relates additionally to a device to carry out the method.

Assuming having a filter device that is provided with a filter chamber that is closed off by a filter mesh from which leads a line for the removal of samples, the inventive device is characterized in that the filter mesh consists of electrically conductive material, at least on its surface, and is connected to a positive electric voltage source as an anode, and that the cathode connected to a negative electric voltage source is arranged at a distance apart from the filter mesh whereby said cathode is electrically insulated from said filter mesh.

The waste water disposed between the filter mesh as anode and cathode serves thereby as an electrolyte. The water, which underwent electrolysis, is rejected. The waste water supplied for analysis has not been influenced by an electrochemical process.

According to a preferred embodiment, it is proposed that the cathode is an annular electrode concentrically encompassing the filter mesh at a distance apart. An especially simple and compact design is thereby achieved.

There can be proposed, instead of the above-described embodiment, that the cathode is a plate electrode arranged at a distance apart in front of the filter mesh. An especially uniform electric field is formed thereby between the filter mesh as an anode and the cathode so that anodic oxidation occurs uniformly distributed in all areas of the filter mesh.

The filter mesh consists preferably of metal. Metal is electrically conductive and has high mechanical stability.

Instead, the filter mesh can also consist of electrically non-conductive material, such as synthetic material or ceramics, provided with a metallic surface layer that ensures electric conductivity on the surface of the filter mesh.

Further advantageous embodiments of the inventive idea are the object in additional minor claims.

Embodiment examples of the invention, which are illustrated in the drawings, are described in more detail in the following.

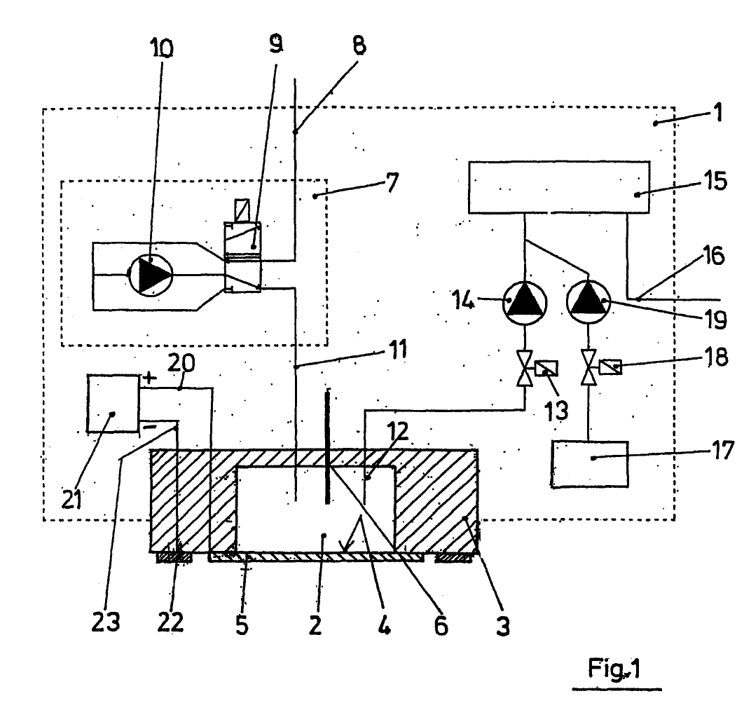

FIG. 1 shows a schematic illustration of a waste water analyzer with a filter device;

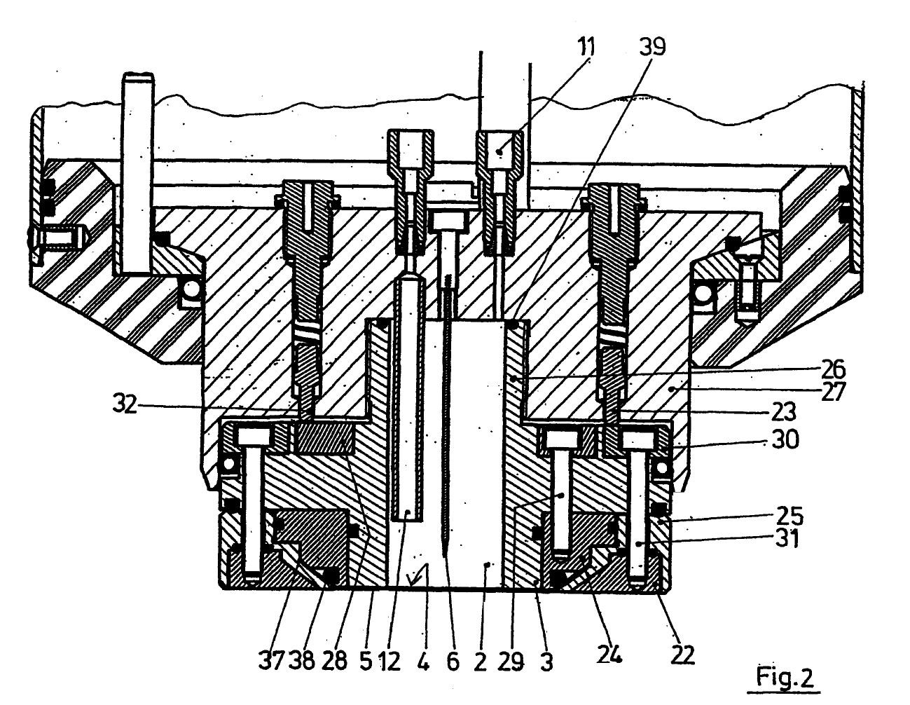

FIG. 2 shows in a longitudinal section the filter device of the analyzer in FIG. 1;

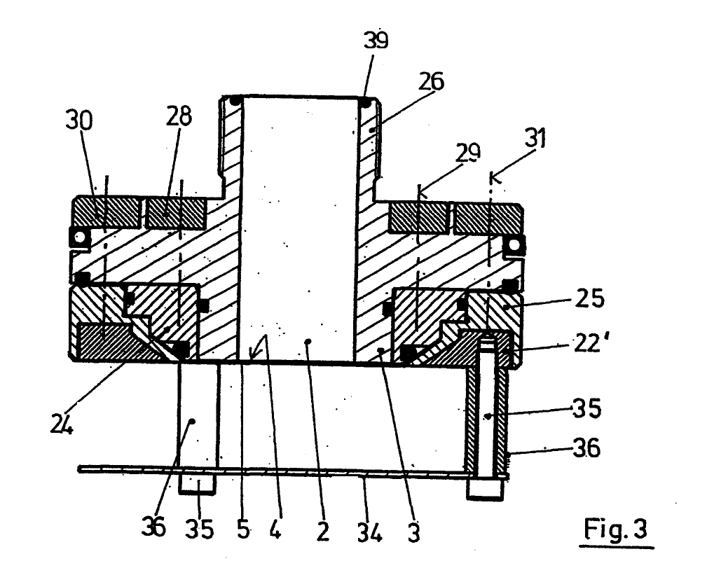

FIG. 3 shows in a longitudinal section corresponding to FIG. 2 a modified embodiment of the filter chamber with the cathode attached thereon.

The waste water analyzer of the type of an in-situ analyzer illustrated schematically in FIG. 1 is designed as a buoy 1 that is immersed in the waste water to be tested. One filter chamber 2 is formed by the chamber housing 3 made of electrically non-conductive material. One chamber opening 4 of the filter chamber 2 is covered by a tensioned filter mesh 5 consisting of metal.

A fluid level sensor 6 projects into the filter chamber 2. A propelling unit 7 serves to move by suction a quantity of filtrate from the surrounding waste water through the filter mesh 5 into the filter chamber 2. An aeration line. 8 is connected to a suction line 11, which leads into the filter chamber 2 via a solenoid valve 9 and an electrically drivable compressor 10.

A sample removal line 12 leads from said filter chamber via a solenoid valve 13 and a pump 14 to a photometric analyzer 15, which is provided with an optical sensor (not illustrated). A discharge line 16 extends from there past the buoy 1.

A reservoir 17 for a color reagent is connected via a solenoid valve 18 and a pump 19 to the connection line of the photometric analyzer 15 and serves to feed a color reagent to the waste water sample to be tested.

The filter mesh 5 made of metal is connected as an anode via an electric line 20 to the positive terminal of an electric DC voltage source 21. An annular electrode 22 encompassing the filter mesh 5 is connected as cathode via an electric line 23 to the negative terminal of the electric voltage source 21.

As shown in detail in FIG. 2, the filter chamber 2 is formed by a chamber housing 3 made of electrically non-conductive material whereby the chamber opening 4 of said chamber is covered by the tensioned filter mesh 5. The chamber housing 3 supports an electrically conductive support ring 24 surrounding the chamber opening 4 against which the edge of the filter mesh 5 is pressed by a clamping ring 25 made of electrically non-conductive material.

The chamber housing 3 is interchangeably screwed onto a housing bottom 27 by means of a central screw socket 26 formed in one piece on said chamber housing 3. A first slip ring 28 arranged on the chamber housing 3 at the side of the equipment is electrically conductive and mechanically connected to the support ring 24 by a plurality of tension screws 29. A second slip ring 30 is arranged on the chamber housing 3 concentrically thereto and on the side of the equipment, and it is also electrically conductive and mechanically connected to the annular electrode 22 forming the cathode by a plurality of axis-parallel tension screws 31. The chamber housing 3 together with its attached parts is thereby fastened to the device bottom 27 as a component that can be easily interchanged.

The two slip rings 28 and 30 are in contact with the respective electric sliding contacts 32 or 33 arranged in the device bottom 27 whereby said sliding contacts extend through the device bottom 27 made of electrically non-conductive material and are connected to the electric voltage source 21 via the lines 20 or 23. The use of slip rings 28, 30 and sliding contacts 32, 33 ensures that an electric connection is established between the filter mesh 5 as anode and the annular electrode 22 as cathode and to the electric DC voltage source 21, independent from the respective screwed-in position reached.

Filling of the filter chamber 2 is achieved in that a negative pressure is created at first in the filter chamber 2 by the propelling unit 7 so that a quantity of filtrate of the waste water to be tested is moved by suction through the filter mesh 5 into the filter chamber 2. The solenoid valve 9, shown in FIG. 1 in its electrically non-powered position, is now electrically powered. The compressor 10 is turned on at the same time. The compressor 10 draws air through the suction line 11 and evacuates it into the atmosphere through the air conduit 8. This process is continued until the fluid level sensor 6 signals filling of the filter chamber 2 at a sufficient level.

A sample quantity of the filtrate is moved from the filter chamber 2 into the photometric analyzer 15 by opening the solenoid valve 13 and by turning on the pump 14. The correspondingly necessary quantity of color reagent is subsequently fed into the analyzer 15 by opening of the solenoid valve 18 and by turning the pump 19 on. The solenoid valve 9 is without electric power in its position shown in FIG. 1 during actuation of the pump 14. The air passage leading from the air conduit 8 to the filter chamber 2 is open thereby. Air can be replenished through the solenoid valve 9 and the compressor 10 when negative pressure is created in the filter chamber 2 through the suction of the pump 14. The pressure differential required for this action is limited to the relatively small force required to open the check valve of the compressor 10. A decrease of negative pressure occurs thereby so that the pressure in the filter chamber 2 lies nearly at the ambient pressure level.

The cleaning of the filter mesh 5, particularly of biological growth, occurs through anodic oxidation. Oxidants are created through electrolysis by charging the electrically conductive filter mesh 5 with positive electric potential by turning on the DC voltage source 21 and by charging the cathode 22 with negative electric potential, whereby the oxidants developing as anode on said filter mesh oxidize the biological growth and prevent clogging of the filter mesh 5 through the growth. This cleaning process through anodic oxidation is performed intermittently between the periods of sample removal—more precisely, it is performed cyclical and several times distributed throughout the day according to needs. The electric current and/or the existing voltage flowing over the cathode and anode are adjusted to the respective cleaning requirement.

The cleaning process by anodic oxidation can be performed at the same time as the measuring operation in the analyzer 15 to optimize time.

In addition to the described cleaning by anodic oxidation, the filter mesh 5 can be cleaned according to need by adding separate chemical cleaning agents.

FIG. 3 shows a modified embodiment of the cathode compared to FIG. 2. While the cathode of the embodiment in FIG. 2 is designed as an annular electrode 22 concentrically encompassing the filter mesh 5 at a distance apart, there is in the embodiment according to FIG. 3, a plate electrode 34 arranged at a distance apart in front of the filter mesh 5 whereby said plate electrode 34 is connected by a plurality of screws 35 and spacer sleeves 36 to a ring 22′ that is similar to the annular electrode 22.

Aside from the above-described embodiment of the filter mesh 5 made of metal, e.g. a metallic web, it can also be proposed to manufacture the filter mesh 5 of electrically non-conductive material, e.g. synthetic material or ceramics, and apply a metallic surface layer to obtain the electric conductivity required for anodic oxidation.

As one can see from FIG. 2 and FIG. 3, the edge of the filter mesh 5 is pressed against a truncated surface 37 of the support ring 24 by the clamping ring 25 and is sealed by means of a sealing ring 38, for instance an O-ring.

The filter chamber 2 is a smooth through-going, essentially cylindrical cavity, for example. The chamber housing 3 or its screw socket 26 is sealed in its screwed-in condition against the housing bottom 27 by means of a seal 39. A simple mechanical cleaning possibility is thereby created in a disassembled condition.

The suction line 11 runs into the filter chamber 2 within the sealed area of the housing bottom 27. The sample removal line 12 and the fluid level sensor 6 project from the region of the housing bottom 27 enclosed by the seal 39 and extend into the filter chamber 2. It is achieved thereby that during the change of the chamber housing 3, none of the connection for these lines 11, 12 and the fluid level sensor 6 have to be detached. The change of the chamber housing supporting the filter mesh 5 is simplified and made considerably easier—mainly since none of the electric connection lines have to be detached because of the electric sliding contacts 23 and 32.

1. A method for removing waste water samples, particularly for photometric analysis, whereby a quantity of filtrate is moved by suction through a filter mesh and a sample is removed therefrom and then analyzed, and whereby the filter mesh is intermittently cleaned between the removal of samples, characterized in that the filter mesh (5) is electrically conductive and charged with positive electric potential as an anode during intermittent cleaning steps to carry out anodic oxidation while a cathode (22, 34) separated from said filter mesh is charged with negative electric potential.

2. A method according to claim 1, whereby a quantity of filtrate is moved by suction through the filter mesh (5) into a filter chamber (2) by creating negative pressure and whereby the negative pressure is mostly formed before and/or during the removal of the sample from the filter chamber (2).

3. A device to carry out the method according to claim 1, having a filter device provided with a filter chamber that is closed off with a filter mesh from which extends a sample removal line, characterized in that the filter mesh (5) consists of electrically conductive material, at least on its surface, and is connected to a positive electric voltage source as an anode, and that the cathode (22, 34) connected to a negative electric voltage source is arranged at a distance apart from the filter mesh (5) whereby said cathode is electrically insulated from said filter mesh.

4. A device according to claim 3, wherein the cathode is an annular electrode (22) concentrically encompassing the filter mesh (5) at a distance apart.

5. A device according to claim 3, wherein the cathode is a plate electrode (34) arranged at a distance apart in front of the filter mesh (5).

6. A device according to claim 3, wherein the filter mesh (5) consists of metal.

7. A device according to claim 3, wherein said filter mesh consists of electrically non-conductive material, such as synthetic material or ceramics, provided with a metallic surface layer.

8. A device according to claim 3, wherein the filter chamber (2) is formed by a chamber housing (3) made of electrically non-conductive material and wherein said chamber housing (3) is provided with a chamber opening (4) covered with tensioned filter mesh (5).

9. A device according to claim 8, wherein the chamber housing (3) supports an electrically conductive support ring (24) surrounding said chamber opening (4) whereby the edge of the filter mesh (5) is pressed against said support ring (24) by a clamping ring (25).

10. A device according to claim 8, wherein the chamber housing (3), together with the parts attached thereon, is fastened to the device bottom (27) as a component that can be easily interchanged.

11. A device according to claim 10, wherein the chamber housing (3) is screwed onto the housing bottom (27) by means of a central screw socket (26), and wherein an electrically conductive first slip ring (28) connected to the support ring (24) and an electrically conductive second slip ring (30) connected to the cathode (22 or 34) are concentrically arranged on the chamber housing (3) and are in contact with the respective electric sliding contacts (32 or 33) arranged in the device bottom (27).

12. A device according to claim 10 or 11, wherein the filter chamber (2) is a smooth, through-going, essentially cylindrical cavity, for example, and wherein the chamber housing (3) or its screw socket (26) is sealed against the housing bottom (27) by means of a seal (39) in the screwed-in condition.
